(19) United States
(12) Patent Application Publication
(10) Pub. No.: US 2014/0021665 A1
(43) Pub. Date: Jan. 23, 2014

(54) VIBRATION AND SHOCK ISOLATOR

(71) Applicant: KOREA ADVANCED INSTITUTE OF SCIENCE AND TECHNOLO, Daejeon (KR)

(72) Inventors: Jae-Hung Han, Daejeon (KR); Ho-Kyeong Jeong, Daejeon (KR); Se-Hyun Yoon, Daejeon (KR); Dae-Oen Lee, Daejeon (KR)

(73) Assignee: KOREA ADVANCED INSTITUTE OF SCIENCE AND TECHNOLOGY, Daejeon (KR)

(21) Appl. No.: 13/708,277

(22) Filed: Dec. 7, 2012

(30) Foreign Application Priority Data
Jul. 19, 2012 (KR) 10-2012-0078757

(51) Int. Cl. F16F 7/00

(52) U.S. Cl. CPC F16F 7/00
USPC 267/140.3; 267/141

(57) ABSTRACT

A vibration and shock isolator may include a resilient member and a compressing member. The resilient member may be connected between a vibrating source and an object. The compressing member may provide the resilient member with a compression displacement in accordance with the vibration characteristics applied to the resilient member from the vibrating source to change stiffness of the resilient member. Thus, a designed natural frequency of the isolator may be simply changed using the shape memory wire to suppress vibration amplification. As a result, the isolator may effectively relieve the shock and the vibration so that a structural stability of a structure may be ensured. Further, the isolator may have a simple structure so that the isolator may have improved reliability and durability.

### CROSS-REFERENCE TO RELATED APPLICATIONS

This application claims priority under 35 USC §119 to Korean Patent Application No. 10-2012-78757, filed on Jul. 19, 2012 in the Korean Intellectual Property Office (KIPO), the contents of which are herein incorporated by reference in their entirety.

### BACKGROUND

1. Field of the Invention

Example embodiments relate to a vibration and shock isolator. More particularly, example embodiments relate to an isolator for relieving a vibration and a shock that may be transmitted from a vibration source to an object.

2. Description of the Related Art

Generally, a vibration and shock isolator may include a resilient member arranged between a vibrating mass and a vibration source. An isolating capacity of the isolator may be determined in accordance with relationship between stiffness of the resilient member and the vibrating mass. A natural frequency of the isolator is directly proportional to the stiffness of the resilient member. In contrast, the natural frequency of the isolator is inversely proportional to the mass of the vibrating source. The natural frequency of the isolator may be used as a design parameter of the isolator.

Transmissibility of an isolator may be represented as a ratio of total transmitted force with respect to an exciting force. When an excitation frequency is greater than about 1.4 times of the isolator's natural frequency, a transmitted force may be lower than the exciting force so that the isolator may function as to relieving the vibration and the shock. However, when the frequency may be substantially similar to the designed natural frequency of the isolator, the transmitted force may be remarkably higher than the exciting force meaning that the transmitted vibration is amplified. Thus, in determining the natural frequency of the isolator, it may be required to accurately grasp characteristics of the vibrating source.

However, an excitation frequency may frequently change in practical vibrational environment. Therefore, the exciting force may be amplified in a specific frequency band. For example, various vibrations and shocks in launch vehicle may be transmitted to payloads of launch vehicle such as spacecrafts. The launch vehicle may have an excitation frequency of no more than about 100 Hz by aerodynamic loads at initial launch phase; while an excitation frequency of upto about 10,000 Hz is generated during the separation events. When the designed natural frequency of the isolator is equal to the excitation frequency, a very high amplification of the vibration and the shock is transmitted. Particularly, when the very high amplification may be generated in a low frequency band, a large vibration displacement may be applied to a structure so that structural stability of the structure may be deteriorated.

Therefore, if the natural frequency of the isolator can be controlled by altering the stiffness of the resilient member when an excitation frequency approaches the designed natural frequency of the isolator, the structural integrity can be ensured by preventing the amplification of the vibration.

The resilient member may be made out of materials having inherent damping such as a rubber, an elastomer, meshed wire structure, etc. Unlike an ideal spring, these resilient members may not have a constant stiffness when they are subjected to compressive loads. That is, the stiffness of the resilient members may be nonlinearly changed in accordance with the applied displacement to the resilient members.

### SUMMARY

Example embodiments provide a vibration and shock isolator that may be capable of effectively relieving a vibration and a shock by suppressing vibration amplification.

According to some example embodiments, there may be provided a vibration and shock isolator. The isolator may include a resilient member and a compressing member. The resilient member may be connected between a vibrating source and an object. In order to change stiffness of the resilient member, the compressing member may provide the resilient member with a compression displacement in accordance with the vibration characteristics applied to the resilient member from the vibrating source.

In example embodiments, the compressing member may include a shape memory wire configured to be contracted at an Af-Austenite finish temperature to provide the resilient member with the compression displacement, and a controller for supplying a current to the shape memory wire to control the temperature of the shape memory wire.

In example embodiments, the shape memory wire may be coiled around an outer surface of the resilient member.

In example embodiments, the shape memory wire may be coiled around an outer surface of the resilient member in a direction substantially parallel to a transmission direction of the vibration and the shock.

In example embodiments, the shape memory wire may be coiled around an outer surface of the resilient member in a direction substantially perpendicular to a transmission direction of the vibration and the shock.

In example embodiments, the compressing member may further include a first compressing plate attached to a first surface of the resilient member, and a second compressing plate attached to a second surface of the resilient member opposite to the first surface. The shape memory wire may be connected between the first compressing plate and the second compressing plate.

In example embodiments, the first surface may be oriented toward the vibrating source. The second surface may be oriented toward the object. The shape memory wire may be extended in a direction substantially parallel to a transmission direction of the vibration and the shock.

In example embodiments, the first surface may be oriented toward a direction substantially perpendicular to a direction oriented toward the vibrating source. The shape memory wire may be extended in a direction substantially perpendicular to a transmission direction of the vibration and the shock.

In example embodiments, the isolator may further include a spring coiled around an outer surface of the resilient member to assist a shape recovery of the resilient member.

In example embodiments, the isolator may further include a first connecting member connected between the vibrating source and the resilient member, and a second connecting member connected between the object and the resilient member.

According to some example embodiments, there may be provided a vibration and shock isolator. The isolator may include a resilient member, a first connecting member, a second connecting member, a shape memory wire and a controller. The resilient member may be arranged between a vibrating source and an object. The first connecting member may be connected between the vibrating source and the resilient member. The second connecting member may be connected between an object and the resilient member. The shape memory wire may be contracted at an Af-Austenite finish temperature to provide the resilient member with a compression displacement, thereby changing stiffness of the resilient member. The controller may supply a current to the shape memory wire to change the temperature of the shape memory wire to the Af-Austenite finish temperature.

In example embodiments, the shape memory wire may be coiled around an outer surface of the resilient member in a direction substantially parallel to a transmission direction of the vibration and the shock.

In example embodiments, the shape memory wire may be coiled around an outer surface of the resilient member in a direction substantially perpendicular to a transmission direction of the vibration and the shock.

In example embodiments, the isolator may further include a first compressing plate attached to a first surface of the resilient member, and a second compressing plate attached to a second surface of the resilient member opposite to the first surface. The shape memory wire may be connected between the first compressing plate and the second compressing plate.

In example embodiments, the first surface may be oriented toward the vibrating source. The second surface may be oriented toward the object. The shape memory wire may be extended in a direction substantially parallel to a transmission direction of the vibration and the shock.

In example embodiments, the first surface may be oriented toward a direction substantially perpendicular to a direction oriented toward the vibrating source. The shape memory wire may be extended in a direction substantially perpendicular to a transmission direction of the vibration and the shock.

In example embodiments, the isolator may further include a spring coiled around an outer surface of the resilient member to assist a shape recovery of the resilient member.

According to example embodiments, a designed natural frequency of the isolator may be simply changed using the shape memory wire to suppress vibration amplification. Thus, the isolator may effectively relieve the shock and the vibration so that a structural stability of a structure may be ensured. Further, the isolator may have a simple structure so that the isolator may have improved reliability and durability.

### BRIEF DESCRIPTION OF THE DRAWINGS

Example embodiments will be more clearly understood from the following detailed description taken in conjunction with the accompanying drawings. FIGS. 1 to 10 represent non-limiting, example embodiments as described herein.

FIG. 1 is a side view illustrating a vibration and shock isolator in accordance with example embodiments;

FIG. 2 is a side view illustrating a vibration and shock isolator in accordance with example embodiments;

FIG. 3 is a perspective view illustrating a vibration and shock isolator in accordance with example embodiments;

FIG. 4 is a side view illustrating the isolator in FIG. 3;

FIG. 5 is a perspective view illustrating a vibration and shock isolator in accordance with example embodiments;

FIG. 6 is a side view illustrating the isolator in FIG. 5;

FIG. 7 is a perspective view illustrating a vibration and shock isolator in accordance with example embodiments;

FIG. 8 is a side view illustrating the isolator in FIG. 7;

FIG. 9 is a side view illustrating a vibration and shock isolator in accordance with example embodiments; and

FIG. 10 is a graph showing isolating characteristics of the isolator in FIG. 3.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

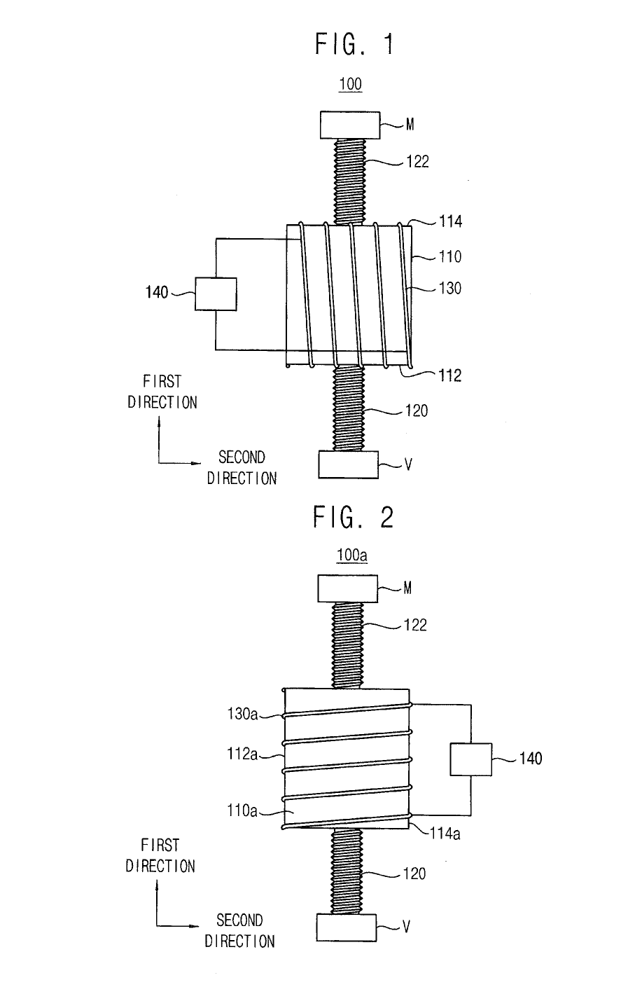

FIG. 1 is a side view illustrating a vibration and shock isolator in accordance with example embodiments.

Referring to FIG. 1, a vibration and shock isolator 100 of this example embodiment may include a resilient member 110, a first connecting member 120, a second connecting member 122 and a compressing member.

The resilient member 110 may be arranged between a vibrating source V and an object M. The resilient member 110 may have a first surface 112 oriented toward the vibrating source V, and a second surface 114 oriented toward the object M and opposite to the first surface 112. In example embodiments, the resilient member 110 may have a cylindrical shape.

In example embodiments, the resilient member 110 may have elasticity and a inherent damping. Thus, the resilient member 110 may relieve vibrations and shocks generated from the vibrating source V and transmitted to the object M. For example, the resilient member 110 may include an elastomer. Alternatively, the resilient member 110 may have a mesh structure.

The first connecting member 120 may be connected between the resilient member 110 and the vibrating source V. Thus, the first connecting member 120 may have a lower end connected to the vibrating source V and an upper end connected to the first surface 112 of the resilient member 110. In example embodiments, the first connecting member 120 may have a screw shape. Therefore, the first connecting member 120 may be threadedly combined with the resilient member 110 and the vibrating source V.

The second connecting member 122 may be connected between the resilient member 110 and the object M. Thus, the second connecting member 122 may have a lower end connected to the second surface 114 of the resilient member 110, and an upper end connected to the object M. In example embodiments, the second connecting member 122 may have a shape and a material substantially the same as those of the first connecting member 120. Therefore, the second connecting member 122 may be threadedly combined with the resilient member 110 and the object M.

The compressing member may provide the resilient member 110 with a compression displacement in accordance with the vibration characteristics applied to the resilient member 110 to change stiffness of the resilient member 110. In example embodiments, the isolator 100 may have a natural frequency. When a frequency of the vibration applied to the resilient member 110 from the vibrating source V may approach the natural frequency of the isolator 100, the vibration may not be relieved in the isolator 100. In contrast, the vibration may be amplified in the isolator 100. In order to prevent the vibration amplification, the compressing member may change the stiffness of the resilient member 110 to alter the natural frequency of the isolator 100, thereby preventing the vibration amplification. In example embodiments, the compressing member may include a shape memory wire 130 and a controller 140.

The shape memory wire 130 may be contracted at an Af-Austenite finish temperature. Thus, when the Af-Austenite finish temperature may be applied to the shape memory wire 130, the shape memory wire 130 may be contracted to an original shape so that the compression displacement may be provided to the resilient member 110 to change the stiffness of the resilient member 110.

In example embodiments, the shape memory wire 130 may be coiled around an outer surface of the resilient member 110. The shape memory wire 130 may be coiled in a first direction substantially parallel to a transmission direction of the vibration and the shock from the vibrating source V to the object M. Thus, the shape memory wire 130 may provide the resilient member 110 with the compression displacement in the first direction. The shape memory wire 130 may include a nickel-titanium alloy, a nickel-titanium-copper alloy, etc. Alternatively, the compressing member may include beam-shaped shape memory member, bar-shaped shape memory member, etc.

The controller 140 may be electrically connected with the shape memory wire 130. The controller 140 may supply a current to the shape memory wire 130 to change the temperature of the shape memory wire 130 to the Af-Austenite finish temperature.

In example embodiments, when a frequency of an input excitation from the vibrating source V may approach the natural frequency of the isolator 100, the vibration may be amplified. In this condition, the controller 140 may supply the current to the shape memory wire 130. The shape memory wire 130 may be gradually heated so that the shape memory wire 130 may have a temperature higher than the Af-Austenite finish temperature. The shape memory wire 130 may be contracted to the original shape to generate very high recovery stresses. The recovery stresses may provide the resilient member 110 with the compression displacement in the first direction so that the stiffness of the resilient member 110 may be nonlinearly increased. As a result, the natural frequency of the isolator 100 may also be increased to suppress the vibration amplification.

FIG. 2 is a side view illustrating a vibration and shock isolator in accordance with example embodiments.

An isolator 100a of this example embodiment may include elements substantially the same as those of the isolator 100 in FIG. 1 except for a resilient member and a shape memory wire. Thus, the same reference numerals may refer to the same elements and any further illustrations with respect to the same elements may be omitted herein for brevity.

Referring to FIG. 2, a first surface 112a of a resilient member 110a may be oriented left. Thus, a second face 114a of the resilient member 110a opposite to the first surface 112a may be oriented right. That is, the first surface 112a and the second surface 114a of the resilient member 110a may be arranged in a second direction substantially perpendicular to the first direction. Here, the second direction may be substantially perpendicular to the transmission direction of the vibration and the shock.

A shape memory wire 130a may be coiled around the outer surface of the resilient member 110a in the second direction in accordance with the arrangement of the resilient member 110a. Therefore, the shape memory wire 130a may provide the resilient member 110a with the compression displacement in the second direction.

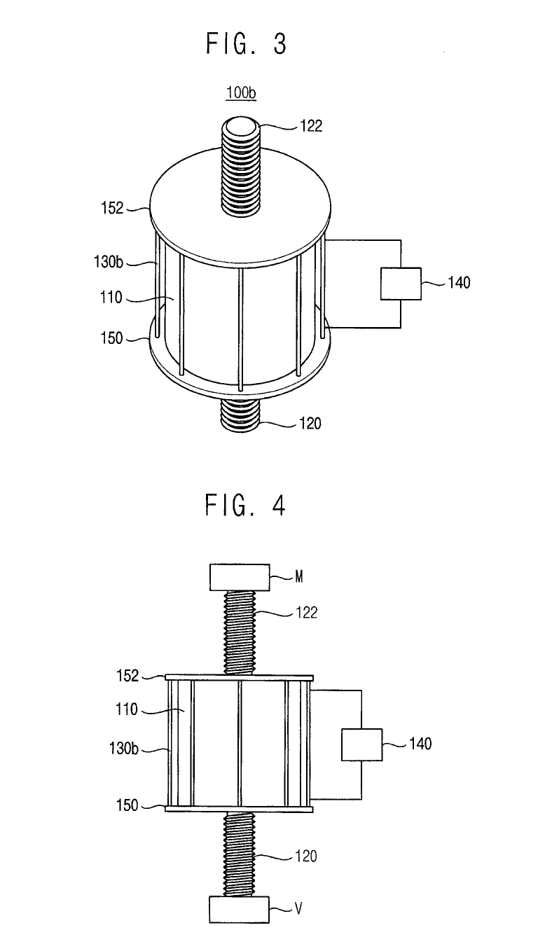

FIG. 3 is a perspective view illustrating a vibration and shock isolator in accordance with example embodiments, FIG. 4 is a side view illustrating the isolator in FIG. 3.

An isolator 100b of this example embodiment may include elements substantially the same as those of the isolator 100 in FIG. 1 except for a position of a shape memory wire and further including a first compressing plate and a second compressing plate. Thus, the same reference numerals may refer to the same elements and any further illustrations with respect to the same elements may be omitted herein for brevity.

Referring to FIGS. 3 and 4, the first compressing plate 150 may be interposed between the resilient member 110 and the first connecting member 120. The first compressing plate 150 may be fixed to the first surface 112 of the resilient member 110. In example embodiments, the first compressing plate 150 may include a circular plate having a diameter longer than that of the resilient member 110. Thus, an edge portion of the first compressing plate 150 may be exposed by the resilient member 110.

The second compressing plate 152 may be interposed between the resilient member 110 and the second connecting member 122. The second compressing plate 152 may be fixed to the second surface 114 of the resilient member 110. In example embodiments, the second compressing plate 152 may have a shape substantially the same as that of the first compressing plate 150. Thus, an edge portion of the second compressing plate 152 may be exposed by the resilient member 110.

The shape memory wire 130b may be connected between edge portions of the first compressing plate 150 and the second compressing plate 152. The shape memory wire 130b may be extended in the first direction. In example embodiments, the shape memory wire 130b may be spaced apart from the outer surface of the resilient member 110. Further, the shape memory wire 130b may include a plurality of wires arranged by substantially the same interval.

In example embodiments, the shape memory wire 130b may not directly make contact with the resilient member 110. The shape memory wire 130b may be indirectly make contact with the resilient member 110 via the first compressing plate 150 and the second compressing plate 152. Thus, the compressive force of the shape memory wire 130b may be transmitted to the resilient member 110 through the first compressing plate 150 and the second compressing plate 152 to provide the resilient member 110 with the compressing displacement in the first direction.

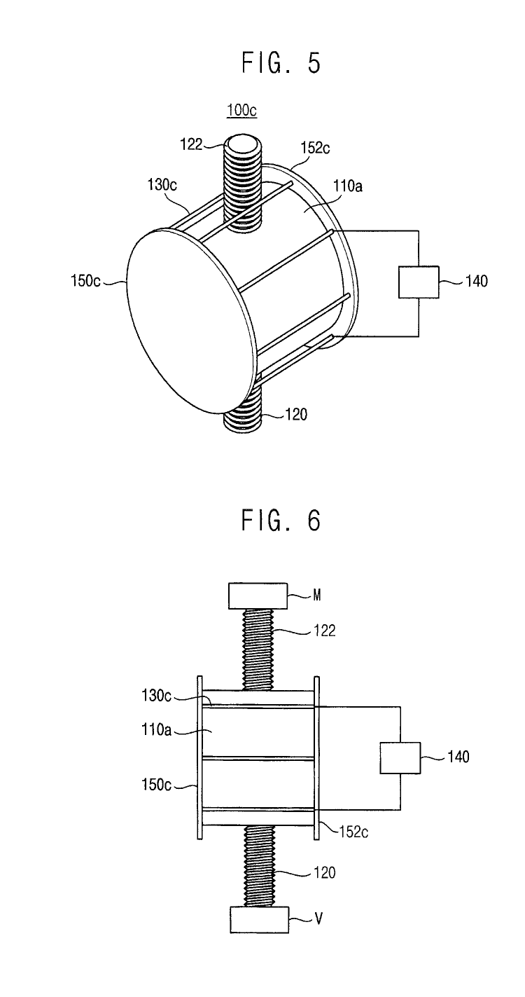

FIG. 5 is a perspective view illustrating a vibration and shock isolator in accordance with example embodiments, FIG. 6 is a side view illustrating the isolator in FIG. 5.

An isolator 100c of this example embodiment may include elements substantially the same as those of the isolator 100a in FIG. 2 except for a position of a shape memory wire and further including a first compressing plate and a second compressing plate. Thus, the same reference numerals may refer to the same elements and any further illustrations with respect to the same elements may be omitted herein for brevity.

Referring to FIGS. 5 and 6, the first compressing plate 150c may be interposed between the resilient member 110a and the first connecting member 120. The first compressing plate 150c may be fixed to the first surface 112a of the resilient member 110a. In example embodiments, the first compressing plate 150c may include a circular plate having a diameter longer than that of the resilient member 110c. Thus, an edge portion of the first compressing plate 150c may be exposed by the resilient member 110a.

The second compressing plate 152c may be interposed between the resilient member 110a and the second connecting member 122. The second compressing plate 152c may be fixed to the second surface 114a of the resilient member 110a. In example embodiments, the second compressing plate 152c may have a shape substantially the same as that of the first compressing plate 150c. Thus, an edge portion of the second compressing plate 152c may be exposed by the resilient member 110a.

The shape memory wire 130c may be connected between edge portions of the first compressing plate 150c and the second compressing plate 152c. The shape memory wire 130c may be extended in the first direction. In example embodiments, the shape memory wire 130c may be spaced apart from the outer surface of the resilient member 110a. Further, the shape memory wire 130c may include a plurality of wires arranged by substantially the same interval.

In example embodiments, the shape memory wire 130c may not directly make contact with the resilient member 110a. The shape memory wire 130c may be indirectly make contact with the resilient member 110a via the first compressing plate 150c and the second compressing plate 152c. Thus, the compressive force of the shape memory wire 130c may be transmitted to the resilient member 110a through the first compressing plate 150c and the second compressing plate 152c to provide the resilient member 110a with the compressing displacement in the second direction.

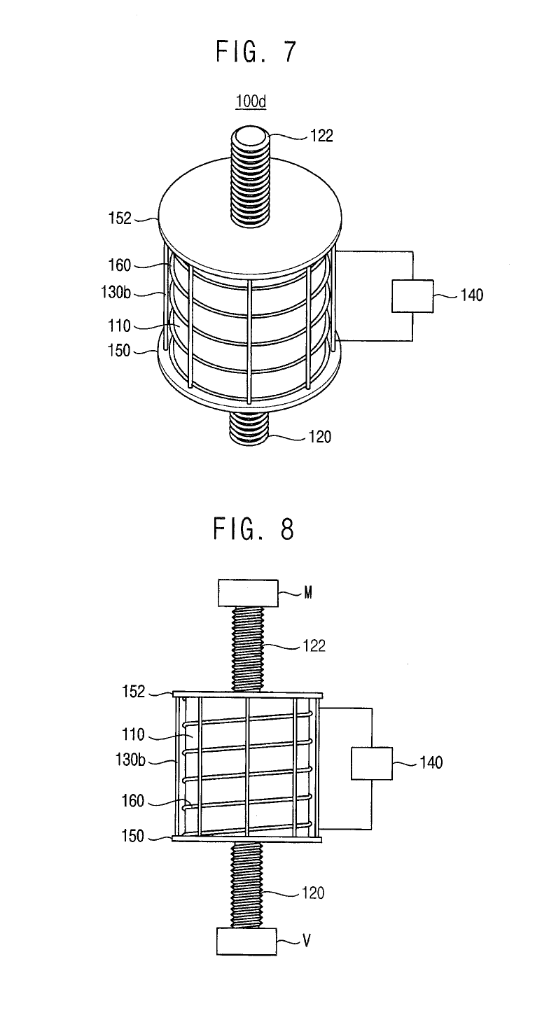

FIG. 7 is a perspective view illustrating a vibration and shock isolator in accordance with example embodiments, FIG. 8 is a side view illustrating the isolator in FIG. 7.

An isolator 100d of this example embodiment may include elements substantially the same as those of the isolator 100b in FIG. 3 except for further including a spring. Thus, the same reference numerals may refer to the same elements and any further illustrations with respect to the same elements may be omitted herein for brevity.

Referring to FIGS. 7 and 8, the spring 160 may be coiled around the outer surface of the resilient member 110. The spring 160 may assist the shape recovery of the resilient member 110.

In example embodiments, when the current may not be supplied to the shape memory wire 130b, the temperature of the shape memory wire 130b may be decreased. Thus, a load for contracting the shape memory wire 130b may be disappeared. Here, the recovery force of the resilient member 110 may elongate the shape memory wire 130b so that the isolator 100d may be returned to an original shape. Thus, the frequency of the isolator 100d may be decreased to an initial value.

However, when the shape memory wire 130b may not be elongated due to the low recovery force of the resilient member 110, the spring 160 may recover the original shape of the resilient member 110. Generally, yield stresses of the shape memory wire 130b may be different in accordance with temperatures. Particularly, the yield stresses of the shape memory wire 130b may be directly proportional to the temperatures. Thus, the spring 160 may assist the compression and the recovery of the resilient member 110.

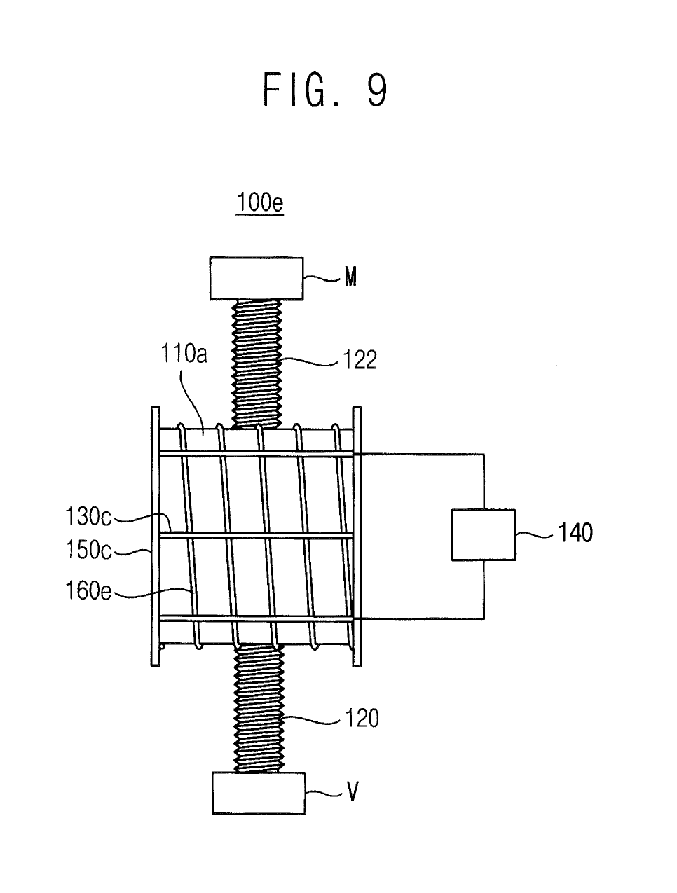

FIG. 9 is a side view illustrating a vibration and shock isolator in accordance with example embodiments.

An isolator 100e of this example embodiment may include elements substantially the same as those of the isolator 100c in FIG. 5 except for further including a spring. Thus, the same reference numerals may refer to the same elements and any further illustrations with respect to the same elements may be omitted herein for brevity.

Referring to FIG. 9, the spring 160e may be coiled around the outer surface of the resilient member 110a. The spring 160e may have functions substantially the same as those of the spring 160 in FIG. 7. Thus, any further illustrations with respect to the functions of the spring 160e may be omitted herein for brevity.

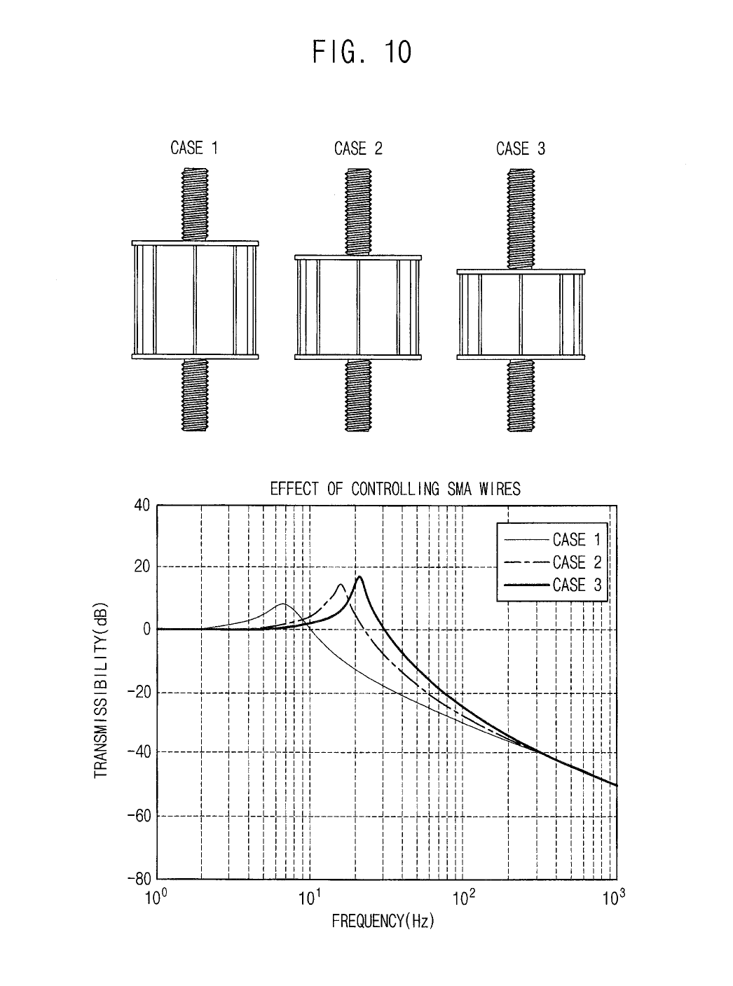

FIG. 10 is a graph showing isolating characteristics of the isolator in FIG. 3.

In FIG. 10, case 1 may represent a state that a shape memory wire may not be heated. Case 2 may represent a state that a half of a shape memory wire may be heated to provide a resilient member with a compression displacement. Case 3 may represent a state that all of a shape memory wire may be heated to provide a resilient member with a compression displacement. In the cases 1 to 3, the compression displacements applied to the resilient members may be different from one another due to the shape memory wires having different temperatures. Therefore, the isolators may have different stiffnesss so that the isolators may have different isolating characteristics. When a structure may be exposed to various vibration environments, the isolator may have a proper isolating characteristic to each of the vibration environments by controlling the natural frequency of the isolator.

According to example embodiments, a designed natural frequency of the isolator may be simply changed using the shape memory wire to suppress vibration amplification. Thus, the isolator may effectively relieve the shock and the vibration so that a structural stability of a structure may be ensured. Further, the isolator may have a simple structure so that the isolator may have improved reliability and durability.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A vibration and shock isolator comprising:
a resilient member connected between a vibrating source and an object; and
a compressing member for providing the resilient member with a compression displacement in accordance with the vibration characteristics applied to the resilient member from the vibrating source to change stiffness of the resilient member.

2. The isolator of claim 1, wherein the compressing member comprises:
a shape memory wire configured to be contracted at an Af-Austenite finish temperature to provide the resilient member with the compression displacement; and
a controller for supplying a current to the shape memory wire to change the temperature of the shape memory wire to the Af-Austenite finish temperature.

3. The isolator of claim 2, wherein the shape memory wire is coiled around an outer surface of the resilient member.

4. The isolator of claim 3, wherein the shape memory wire is coiled in a direction substantially parallel to a transmission direction of the vibration and the shock.

5. The isolator of claim 3, wherein the shape memory wire is coiled in a direction substantially perpendicular to a transmission direction of the vibration and the shock.

6. The isolator of claim 2, wherein the compressing member further comprises a first compressing plate attached to a first surface of the resilient member and a second compressing plate attached to a second surface of the resilient member opposite to the first surface, and the shape memory wire is connected between the first compressing plate and the second compressing plate.

7. The isolator of claim 6, wherein the first surface is oriented toward the vibrating source, the second surface is oriented toward the object, and the shape memory wire is extended in a direction substantially parallel to a transmission direction of the vibration and the shock.

8. The isolator of claim 6, wherein the first surface is oriented toward a direction substantially perpendicular to a direction oriented toward the vibrating source, and the shape memory wire is extended in a direction substantially perpendicular to a transmission direction of the vibration and the shock.

9. The isolator of claim 1, further comprising a spring coiled around an outer surface of the resilient member to assist a shape recovery of the resilient member.

10. The isolator of claim 1, further comprising:
a first connecting member connected between the vibrating source and the resilient member; and
a second connecting member connected between the object and the resilient member.

11. A vibration and shock isolator comprising:
a resilient member connected between a vibrating source and an object;
a first connecting member connected between the vibrating source and the resilient member;
a second connecting member connected between the object and the resilient member;
a shape memory wire configured to be contracted at an Af-Austenite finish temperature to provide the resilient member with the compression displacement; and
a controller for supplying a current to the shape memory wire to change the temperature of the shape memory wire to the Af-Austenite finish temperature.

12. The isolator of claim 11, wherein the shape memory wire is coiled in a direction substantially parallel to a transmission direction of the vibration and the shock.

13. The isolator of claim 11, wherein the shape memory wire is coiled in a direction substantially perpendicular to a transmission direction of the vibration and the shock.

14. The isolator of claim 11, further comprising a first compressing plate attached to a first surface of the resilient member and a second compressing plate attached to a second surface of the resilient member opposite to the first surface, and wherein the shape memory wire is connected between the first compressing plate and the second compressing plate.

15. The isolator of claim 14, wherein the first surface is oriented toward the vibrating source, the second surface is oriented toward the object, and the shape memory wire is extended in a direction substantially parallel to a transmission direction of the vibration and the shock.

16. The isolator of claim 14, wherein the first surface is oriented toward a direction substantially perpendicular to a direction oriented toward the vibrating source, and the shape memory wire is extended in a direction substantially perpendicular to a transmission direction of the vibration and the shock.

17. The isolator of claim 11, further comprising a spring coiled around an outer surface of the resilient member to assist a shape recovery of the resilient member.
